(19) United States
(12) Patent Application Publication
(10) Pub. No.: US 2008/0307206 A1
(43) Pub. Date: Dec. 11, 2008

(54) METHOD AND APPARATUS TO EFFICIENTLY EVALUATE MONOTONICITY

(75) Inventors: Premysl Vaclavik, Vienna (AT); Alois Hahn, Vienna (AT)

Correspondence Address: SCHNECK & SCHNECK, P.O. BOX 2-E, SAN JOSE, CA, 95109-0005, US

(73) Assignee: ON DEMAND MICROELECTRONICS, Vienna (AT)

(21) Appl. No.: 11/946,755

(22) Filed: Nov. 28, 2007

Related U.S. Application Data
(60) Provisional application No. 60/867,406, filed on Nov. 28, 2006.

(51) Int. Cl. G06F 9/305

(52) U.S. Cl. 712/223; 712/E09.018

(57) ABSTRACT

A method and processor to evaluate a monotonicity of a set of input values is disclosed. The processor achieves high processing power by means of an arbitrary number of identical parallel processing elements. Each processing element allows instruction dependent data paths and makes use of ALU factories which consist of a number of separate arithmetic logical units (ALUs) are arranged in a special kind of matrix. The processor allows parallel evaluation and analysis of the monotonicity of a multitude of sets of values. A threshold value can be freely configured to allow an uncertainty of nearly equal values which is of high importance in digital signal processing.

### CROSS-REFERENCE TO RELATED APPLICATION

This application claims priority from U.S. Provisional Patent Application Ser. No. 60/867,406 entitled “Method and Apparatus to Efficiently Evaluate Monotonicity,” filed Nov. 28, 2006 and which is hereby incorporated by reference in its entirety.

### TECHNICAL FIELD

The invention relates in general to micro-processors and in particular to a processor architecture having an instruction to evaluate and analyze the monotonicity of a series of input values.

### BACKGROUND

Signal smoothness and scale are fundamental qualities in signal processing and allow for analyzation and interpretation of digital signals. This even applies for two-dimensional signals such as images. In digital signal processing, e.g., digital image and video processing, such qualities are used to analyze and to improve the quality of the images. In the publication “locally monotonic models for image and video processing” Acton et al. introduces definitions for locally monotonic images and presents algorithms which compute local monotonic versions of images.

Local monotonicity provides a useful criterion for image smoothing, image scaling and image denoising. Acton et al. provides definitions for the property of local monotonicity for images or video. A one-dimensional signal is called locally monotonic of degree d (LOMO-D) if every interval of length d is monotonic. However, an image is called locally monotonic if, in a weak case, every point is at least in one direction LOMO-d and in a strong case if every one-dimensional path in the image is LOMO-d.

Sophisticated image and video algorithms exploit monotonicity. However, the conventional approach of calculation of the monotonicity of a series of pixels requires huge additional computational performance as different cases of monotonicity exist and each case of monotonicity is described by a complex equation. Moreover, this property has to be calculated for each pixel or for a group of pixels within an image in selected directions. Hence, it is necessary to provide a mechanism and an apparatus to allow an efficient evaluation of the monotonicity of a group of pixels.

### GLOSSARY OF TERMS

ALU is an arithmetic logic unit portion of a processor.

Array refers to an arrangement of elements in one or more dimensions. An array can include an ordered set of data items (array elements) which in computer programming languages like Fortran are identified by a single name. In other languages such a name of an ordered set of data items refers to an ordered collection or set of data elements, all of which have identical attributes. A program array has dimensions specified generally by a number or dimension attribute. The declarator of the array may also specify the size of each dimension of the array in some languages. In some languages, an array is an arrangement of elements in a table. In a hardware sense, an array is a collection of structures (functional elements) which are generally identical in a parallel architecture. Array elements in data parallel computing are elements which can each execute independently and in parallel any operations required. Generally, arrays may be thought of as grids of processing elements (PEs). However, data can be indexed or assigned to an arbitrary location in an array.

An array processor uses several processing elements to exploit parallelism. There are mainly two principal types of array processors—multiple instruction multiple data (MIMD) and single instruction multiple data (SIMD). An exemplary embodiment of a processor described herein has other characteristics.

A functional unit is an entity of hardware, software, or both capable of accomplishing a purpose.

GB refers to a billion bytes. GB/s would be a billion bytes per second.

Image processing is defined herein as any kind of information processing for which both an input and output are images. The images are two-dimensional.

MIMD is used to refer to an array processor architecture wherein each processing element in the array has its own instruction stream, thus giving a multiple instruction stream, to execute multiple data streams located one per processing element (PE).

Module is a program unit that is discrete and identifiable or a functional unit of hardware designed for use with other components. Also, a collection of PEs contained in a single electronic chip is called a module.

PE is a processing element. A PE has its own set of registers along with some means for it to receive unique data (such as a data value for a particular pixel in an image) and to execute instructions on these data.

SIMD is a single instruction multiple data array processor architecture wherein all processors in the array are commanded from a single instruction stream to execute multiple data streams located one per processing element.

SISD is an acronym for Single Instruction Single Data.

Video processing is defined herein as a special kind of image processing whereas for the calculation of a single output image a series of at least two input images are necessary. A typical application is deinterlacing which calculates interleaving lines from a series of consecutive images. Video processing is often termed three-dimensional with the sequence of images forming the third dimension.

VLIW is an acronym for very long instruction word.

### SUMMARY OF THE INVENTION

A method and processor to evaluate monotonicity of a set of input values is disclosed. The monotonicity of a set of values is defined by a series of monotonicity conditions, whereas each monotonicity condition identifies a case of monotonicity. Each case of monotonicity can be assigned a monotonicity value. A threshold value can be freely configured to allow an uncertainty of nearly equal values which is of high importance in digital signal processing.

The processor architecture itself achieves high processing power by means of an arbitrary number of identical or highly similar parallel processing elements. Each processing element allows instruction dependent data paths and makes use of ALU factories which consist of a number of separate arithmetical and logical units (ALUs) arranged in a special kind of matrix. The processor allows parallel evaluation and analysis of the monotonicity of a multitude of sets of values within a single clock cycle.

In an exemplary embodiment, the present invention is a processor architecture used in digital signal processing to efficiently analyze monotonicity of a set of N input values. The processor architecture includes a means for comparing the set of N input values and generating N comparison signals where each of the N comparison signals indicating a higher value of two different input values from the set of N input values; a means for calculating N absolute differences of the two different input values; a set of N comparators coupled to the means for calculating N absolute differences and configured to determine which of the N absolute differences are greater than a reference value where each of the set of N comparators is further configured to generate a second comparison signal indicating whether a absolute difference is greater than the reference value; a plurality of logic elements coupled to the set of N comparators and configured to check a plurality of cases of monotonicity where each logic element of the plurality of logic elements configured to determine a unique case of monotonicity using one of the N comparison signals and the second comparison signal and generating a control signal, the control signal indicating whether the unique case of monotonicity of the plurality of cases of monotonicity is valid; and a selection unit coupled to the plurality of logic elements and configured to select a monotonicity output value.

In another exemplary embodiment, the present invention is a processor architecture used in digital signal processing to efficiently analyze monotonicity of a set of N input values. The processor architecture includes a comparison logic circuit configured to compare the set of N input values and generate N comparison signals where each of the N comparison signals indicating a higher value of two different input values from the set of N input values; a calculation circuit coupled to the comparison logic circuit and configured to calculate N absolute differences of the two different input values; a set of N comparators coupled to the calculation circuit configured to determine which of the N absolute differences are greater than a reference value where each of the set of N comparators is further configured to generate a second comparison signal indicating whether a absolute difference is greater than the reference value; a plurality of logic elements coupled to the set of N comparators and configured to check a plurality of cases of monotonicity where each logic element of the plurality of logic elements configured to determine a unique case of monotonicity using one of the N comparison signals and the second comparison signal and generating a control signal, the control signal indicating whether the unique case of monotonicity of the plurality of cases of monotonicity is valid; and a selection unit coupled to the plurality of logic elements and configured to select a monotonicity output value.

In another exemplary embodiment, the present invention is a method of determining monotonicity of a set of N input values. The method includes pairwise comparing the set of N input values to determine a higher value of two different input values from the set of N input values; calculating N absolute differences of the two different input values; determining which of the N absolute differences are greater than a given reference value; checking a plurality of cases of monotonicity, the checking performed using a set of monotonicity conditions evaluated with a result of the step of pairwise comparing and the step of determining which of the N absolute differences are greater, the checking generating control signals indicating which case of monotonicity of the plurality of cases of monotonicity is valid; and using the generated control signals to select a monotonicity output value from a set of output values, the monotonicity output value being a result of a monotonicity instruction.

### BRIEF DESCRIPTION OF THE DRAWINGS

The appended drawings illustrate exemplary embodiments of the invention and must not be considered as limiting its scope.

FIG. 1 shows in simplified form an embodiment of the present invention. A processor 100 comprises a VLIW architecture which contains an arbitrary number of parallel processing elements or slices 101.

FIG. 2 shows in simplified form an exemplary implementation 200 of a slice 101 which has two local memories, an input register array, and an ALU factory 240.

FIG. 3 shows in simplified form an exemplary implementation 300 of an ALU factory 240 comprising four ALUs 305 of type ALU-A, four ALUs 315 of type ALU-B and four ALUs 325 of type ALU-C whereas the input values to the ALUs are distributed via VLIW-controlled multiplexers 303, 313, 323.

FIG. 4 shows in simplified form an exemplary embodiment 400 of an implementation of a monotonicity function using a reference value to allow a particular “uncertainty.”

FIG. 5 shows in simplified form classifications of monotonicity used in the exemplary implementation of FIG. 4.

### DETAILED DESCRIPTION

In the following description, a new method and apparatus to evaluate the monotonicity of a set of input values is disclosed. An associated processor achieves high processing power by means of an arbitrary number of identical or highly similar parallel processing elements. Each processing element allows instruction dependent data paths and makes use of ALU factories which consist of a number of separate arithmetical and logical units (ALUs) which are arranged in a special kind of matrix. The processor allows parallel evaluation and analysis of the monotonicity of a multitude of sets of values. A threshold value can be freely configured to allow an uncertainty of nearly equal values which is of high importance in digital signal processing.

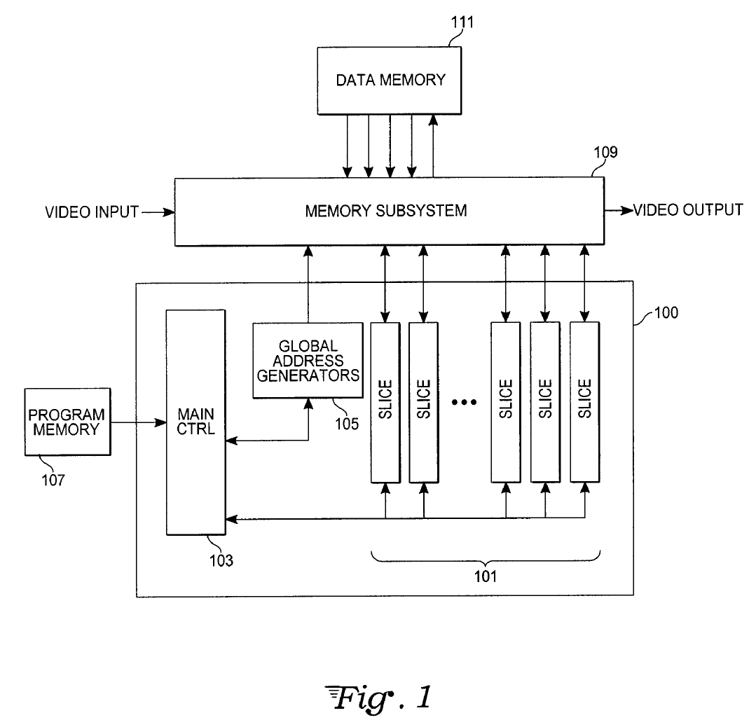

FIG. 1 shows the block diagram of an exemplary processor 100 architecture. The processor 100 includes a main control unit 103, a global address generation unit 105, a plurality of parallel processing units, or slices, 101 and several interfaces. The processor 100 makes use of an approach similar to SIMD (single instruction multiple data) approach and uses a Harvard Architecture. That is, a program memory 107 and an external data memory 111 are decoupled over separate buses. However, in the case shown in FIG. 1 the processor 100 is not directly connected to the data memory 111. Instead, each of the plurality of slices 101 can read and write data from and to a memory subsystem 109 over four 20 bit read ports and one 40 bit write port. Data memories are connected to the plurality of slices 101 and allow temporary data storage. The global address generation unit 105 generates y global address pointers GAPy which can be used to access data in the data memory 111 through the memory subsystem 109.

The memory subsystem 109 receives an incoming video stream, arranges images in an appropriate format in the external data memory 111, and allows external devices (not shown) to access calculated output images. Moreover, the memory subsystem 109 connected to the processor 100 is responsible for providing the correct data for each of the plurality of slices 101 and, hence, acts as a cache for the external data memory 111. Even for a scaling algorithm or complex algorithms like de-interlacing the memory subsystem 109 is important. The memory subsystem 109 caches several lines from a current, previous, and succeeding images of the sequence of the video stream stored in the external data memory 111 and manages to read and to write the calculated pixels back to the output memory within the external data memory 111. While one video line is processed, other video lines are loaded in parallel and the caches are switched when a subsequent line has to be processed.

Hence, the actual implementation of the memory subsystem 109 is dependent upon the algorithms used. For instance, de-interlacing algorithms need the current, previous, and succeeding images of a video stream. On the contrary, simple image processing algorithms like noise reduction require only the current image. Hence, depending on the application, the memory subsystem 109 can be a complex memory management and caching system or even a simple line cache. However, an architecture of the memory subsystem 109 would be understood to a skilled artisan is thus not within a scope of the present invention.

The main control unit 103 is a global sequencer which fetches and decodes instruction words and fills and controls the program flow and the instruction pipeline during processing even in case of interrupts, stops, loops, and jumps. The main control unit 103 synchronizes the execution and data flow within each of the plurality of slices 101 according to the program read from the program memory 107.

The plurality of slices 101 are each identical or similar to one another, whereby a total number of the plurality of slices 101 which are integrated in the core can be chosen freely up to the processing power requirements of the application. For instance, low power applications may use one or a few slices only whereas high performance solutions may include 40 slices or more. As the processor 100 is a full scalable architecture, the total number of the plurality of slices 101 does not influence the processor behavior itself as the plurality of slices 101 operate independently from each other. However, the memory subsystem 109 mentioned above has to support the data throughput to and from all of the plurality of slices 101. Thus, the processor 101 architecture is suitable for system-on-chip (SOC) solutions even for a moderate number of slices, for example, 40 or 64 slices. The processor 100 architecture therefore enables high processing power and manufacturing of the processor 100 on a single chip. As an example, selecting the plurality of slices to be 40 results in an achievable I/O bandwidth for the processor 100 of 560 GB/s if operated at 400 MHz.

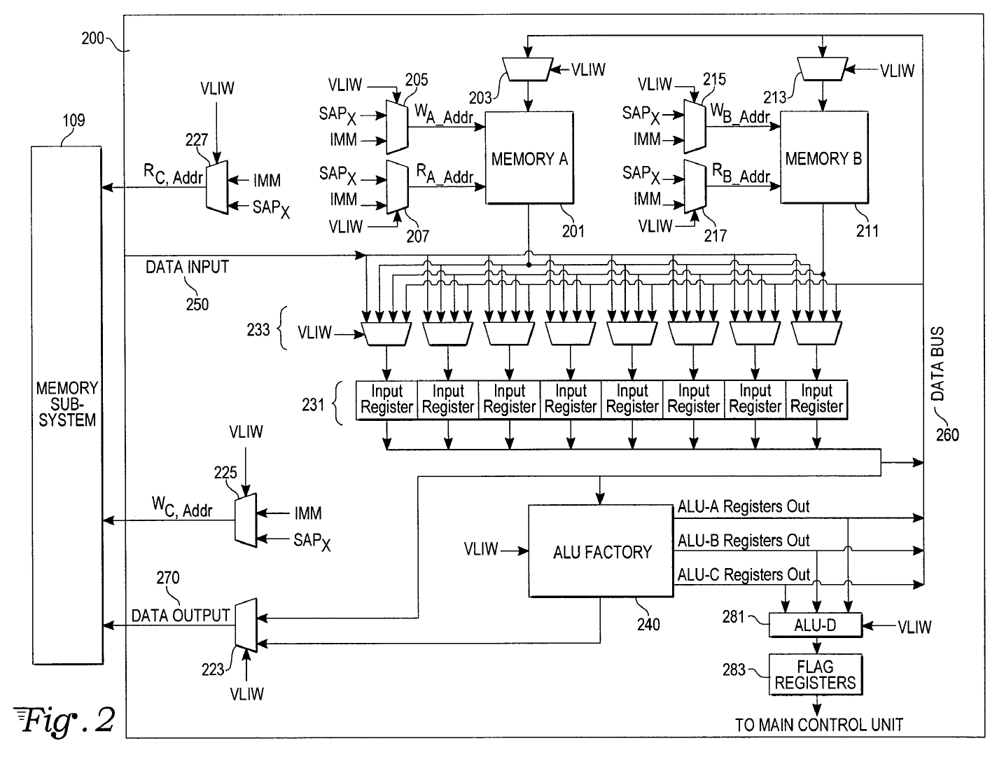

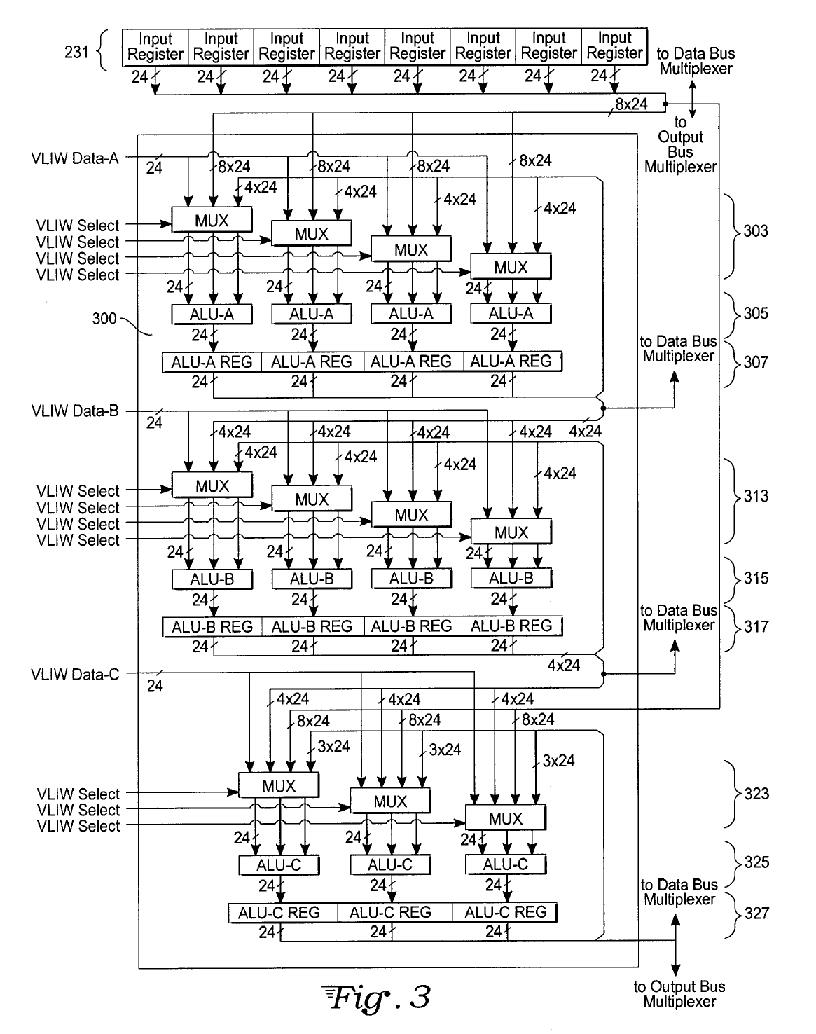

The internal data width of the embodiments depicted in FIG. 1, FIG. 2, and FIG. 3 may be, in a specific exemplary embodiment, 24 bit. This data width is especially suitable for video and image processing, however it is not intended to limit the scope of the disclosure. Moreover, other embodiments of the disclosure can split the word of, e.g., 24 bit into two half-words of, e.g., 12 bits each whereas the half-words can be accessed and used independently for computation.

FIG. 2 shows an exemplary embodiment of a single slice 200 as it can be used in the plurality of slices 101 of the processor 100 architecture of FIG. 1. The slice 200 can read data through a data input 250 from the external memory subsystem 109, perform complex operations on the data, and write back data through a data output 270 to an output bus. The data output 270 can be sent back to the memory subsystem 109.

An ALU factory 240 forms the core of the slice 200. The ALU factory 240 is used as a black box within the slice 200 architecture and is described in detail, below. However, it is of importance to outline some key facts of the ALU factory 240 black box in order to understand the slice 200. At each clock cycle the ALU factory 240 can read data from a plurality of input registers 231 and execute a set of, e.g., mathematical, statistical or logical operations, based on these data. The ALU factory 240 comprises several operational stages. The output of some or all operational stages of the ALU factory 240 can be fed to a slice-internal data bus 260. As an example, in FIG. 2 the output of these stages in the ALU factory 240 are called “ALU-A registers out,” “ALU-B registers out,” and “ALU-C registers out.” The ALU factory 240 can be controlled via the VLIW.

The data bus 260 in the slice 200 architecture is a broad data bus that comprises the output data of the plurality of input registers 231 and the output data buses of the ALU factor 240 comprising the ALU-A registers out, ALU-B registers out, and ALU-C registers out.

The slice 200 can have a set of x address generators or slice address generation units. Hence, in addition to the global addresses generated by the global address generator 105, each slice 200 can generate and use x addresses for itself However, the architecture and capabilities of the global address generator 105 is not of importance for the disclosure. Each of the slice address generation units computes a memory address, a slice address pointer SAP, which can be used as a read or write address for its slice to access a memory A 201, a memory B 211, and the memory subsystem 109.

In a specific exemplary embodiment, the memory A 201 and the memory B 211 may be of equal size and capabilities and are controlled in similar fashions. Both the memory A 201 and the memory B 211 are dual-ported, i.e., data can be read and written in a single clock cycle. At each clock cycle a certain number of data words, e.g, 4 data words, can be stored in each of the memory A 201 and the memory B 211 whereas the data words are selected from the data bus 260 by VLIW-controlled multiplexers 203, 213, respectively. The memory write addresses for the memory A 201 and the memory B 211 are selected from a set of available address pointers by VLIW-controlled multiplexers 205, 215, respectively, whereas the set of address pointers can comprise the slice address pointers SAPx and immediate address values contained in the VLIW. Moreover, at each clock cycle a certain number of data words, e.g, 2 data words, can be read from each of the memory A 201 and the memory B 211 and are sent to the plurality of multiplexers 233. The memory write addresses for the memory A 201 and the memory B 211 are selected from a set of available address pointers by the VLIW-controlled multiplexers 207, 217, respectively, whereas the set of address pointers can comprise the slice address pointers SAPx and immediate address values contained in the VLIW.

At each clock cycle the plurality of input registers 231 read values from the plurality of multiplexers 233. The plurality of multiplexers 233 are controlled by the VLIW and allow for each of the plurality of input registers 231 to select one value from the multitude of values provided by the data bus 260, the memory A 201 and the memory B 211, and the memory subsystem 109. Hence, in one clock cycle each of the plurality of input registers 231 can perform one of the following actions: hold its value, read a value from one of the other input registers, read a value from one of the outputs of the ALU factory 240, read a value from one of the memory A 201 and the memory B 211, or read a value from the memory subsystem 109.

The slice 200 can provide a read address R_{C—Addr} to the memory subsystem. The read address R_{C—Addr} can be selected by the VLIW-controlled multiplexer 227 from the set of addresses given by the slice address pointers SAPx and the immediate address values IMM contained in the VLIW. With reference again to FIG. 1, the global address generator 105 provides global address pointers GAPY to the memory subsystem 109 as well. It is up to the implementation of the memory subsystem 109 which address is used for the read process.

The slice 200 can provide a write address W_{C—Addr} to the memory subsystem 109. The write address W_{C—Addr} can be selected by the VLIW-controlled multiplexer 225 from the set of addresses given by the slice address pointers SAPx and the immediate address values IMM contained in the VLIW. As shown in FIG. 1, the global address generator 105 provides global address pointers GAPy to the memory subsystem 109 as well. It is up to the implementation of the memory subsystem 109 which address is used for the write process.

Referring again to FIG. 2, a VLIW-controlled ALU-D 281 can use an output of the operational stages of the ALU factory 240 to compute flag values which can be stored in a flag register 283. The flag values can be used for conditional execution.

FIG. 3 shows a specific exemplary embodiment of an ALU factory 300 of the ALU factory 240 of FIG. 2. The ALU factory 300 includes three operational stages. Each operational stage—further only referred to as stage—comprises ALUs of the same or similar type, multiplexers, and output registers. ALUs of the same type are identical or highly similar, have the same number of inputs, the same number of outputs, and the same instruction set. However, each ALU within a stage can operate on different data and can execute different instructions within its instruction set. The ALU factory 300 can be controlled via the VLIW denoted by VLIW select.

In the ALU factory 300, the first operational stage has 4 independent ALUs 305 of type ALU-A, the second stage has 4 independent ALUs 315 of type ALU-B, and the third stage has 3 independent ALUs 325 of type ALU-C. All ALUs of type ALU-A have the instruction set I_{A}, all ALUs of type ALU-B have the instruction set I_{B}, and all ALUs of type ALU-C have the instruction set I_{C}.

Each ALU within the ALU factory 300 has at least one input. In the specific exemplary embodiment of FIG. 3, the ALUs 305 of type ALU-A have each 3 independent inputs, the ALUs 315 of type ALU-B have each 5 independent inputs, and the ALUs 325 of type ALU-C have each 3 independent inputs. The inputs of the ALUs are selected from a multitude of values by VLIW-controlled multiplexers. The plurality of multiplexers 303 allow for each ALU 305 of type ALU-A to select its input values from a set of values whereas this set of values comprises the values of all of the plurality of input registers 231, the values of all ALU-A registers 307, and immediate values contained in the VLIW—called VLIW Data A. A plurality of multiplexers 313 allow for each ALU 315 of type ALU-B to select its input values from a set of values whereas this set of values comprises the values of all ALU-A registers 307, the values of all ALU-B registers 317, and immediate values contained in the VLIW—called VLIW Data B. The plurality of multiplexers 323 allow for each ALU 325 of type ALU-C to select its input values from a set of values whereas this set of values comprises the values of all ALU-B registers 317, the values of all ALU-C registers 327, the values of all input registers 231, and immediate values contained in the VLIW—called VLIW Data C.

The values computed by the ALUs in the ALU factory 300 are stored in registers. Each ALU can have its own output register. The ALU-A registers 307 store values computed by the ALUs 305 of type ALU-A. The ALU-B registers 317 store the values computed by the ALUs 315 of type ALU-B. The ALU-C registers 327 store the values computed by the ALUs 325 of type ALU-C.

In the structure shown in FIG. 3, the output of the ALU-A registers 307, the ALU-B registers 317, and the ALU-C registers 327 are sent back to the data bus of the slice 200 as shown in FIG. 2. According to the embodiment of FIG. 3, only the output of the ALU-C registers 327 are sent to the output bus.

One benefit of the structure of the ALU factory 300 is that several data paths exist among the ALUs. The data paths are programmable and all the data paths through the ALU factory 300 are a result of the combination of instructions used in the ALUs. As an example, one ALU of the ALUs 315 of type ALU-B could be used to accumulate the results of all ALUs 305 at each clock cycle while the other ALUs 315 of type ALU-B execute different instructions. Another example can be, that one ALU of the ALUs 305 of type ALU-A contained in the first stage accumulates values loaded in some of the input registers 231 at each clock cycle, while a different ALU in the same stage holds and updates the number of values accumulated so far, and while a third ALU in the same first stage calculates the actual mean value which is determined by the accumulated value divided by the number of values.

As mentioned above, each of the ALUs can perform different operations at a certain clock cycle. The specifc exemplary embodiment of the architecture of the ALU factory 300 shown in FIG. 3 comprises in total 11 ALUs whereas all instructions available in the instruction sets I_{A}, I_{B}, and I_{C} of all ALU types can be executed in a single clock cycle. Hence, in a single clock cycle, 11 instructions can be executed in parallel. Examples that demonstrate benefits of such architectures are given below. Both the plurality of slices 101 (FIG. 1) and the ALU factory 240 (FIG. 2) contained in each of the plurality of slices 101 are controlled via the VLIW. The VLIW contains the 11 instructions for the ALUs, all immediate values, and all the control information for VLIW-controlled components. However, the same VLIW is applied to all of the plurality of slices 101 and, hence, the same 11 instructions contained in the VLIW are executed in all ALU factories 300 of all the plurality of slices 101 in parallel. A programmer has to provide all instructions for all ALUs to be executed at a certain clock cycle properly. However, the programmer has to follow the staged mechanism and to take the data flow into account, i.e., the instruction executed in an ALU of a certain stage can only operate on data read from registers of the same or another stages, e.g., the previous stage, whereas these data have to be computed in the clock cycle before by those ALUs which correspond to the used registers.

The instruction set of the whole ALU factory 300 as described above comprises the instruction sets of all ALU types. Each ALU type of the ALUs shown in FIG. 3 can have a special instruction to evaluate the monotonicity of a given set of input values. As described above, monotonicity is a quality criteria in digital signals and even images. The monotonicity normally is evaluated for a given range of pixels in a direction. According to the example shown in FIG. 3, each of the ALUs 305 of type ALU-A, each of the ALUs 315 of type ALU-B, and each of the ALUs 325 of type ALU-C can have a monotonicity function to evaluate the monotonicity of its input values. However, one embodiment provides a monotonicity function in the ALUs 315 of type ALU-B to evaluate the monotonicity on pre-calculated values of the prior ALU-A stage.

A monotonicity instruction according to the description given herein analyzes its input values and returns a value that determines a correlation of the input values. For example, let's consider five input values a, b, c, d, and e. The extreme situations of monotonicity of a series of monotone increasing values like a<b<c<d<e or a series of monotone decreasing values a>b>c>d>e have to be detected as well as peaks like a<b<c>d>e or a>b>c<d<e. Other cases of monotonicity might be a=b>c=d=e or similar. Depending on the number of input values an arbitrary number of monotonicity cases can be defined. The set of monotonicity cases of choice is dependent upon the application.

Monotonicity sometimes is used to determine if certain input values are higher or lower than others. In other cases monotonicity is used to determine if any combination of the input values matches a monotonicity condition such as a>b=c=d=e.

Although these examples use five input values (a, b, c, d, and e), the same cases could be covered with a monotonicity function that uses only three input values as well. For instance, to determine if a>b>c>d>e is true, one could even check for both a>b>c and c>d>e. Hence, the monotonicity of a series of N values can be determined also with several calls to a function that analyzes the monotonicity of M values, where M<N. The lower M is the more partial monotonicity analyzes have to be performed and the more cycles are necessary to compose the partial monotonicity analyzes. For example, if M=2 (this is a simple “greater than,” “less than,” or “equal to” operation), four partial analysis (a<b, b<c, c<d, and d<e) are four “AND” operations are necessary to combine these partial monotonicity case analysis to a whole monotonicity case of the five input values for a<b<c<d<e. As discussed above, simple comparator operations like “less than” and “greater than” are not sufficient to efficiently handle evaluation of monotonicity of a series of values. On the other hand, a monotonicity function that analyzes a high number of input values (e.g., seven or more) would result in a complex circuit. Our analysis have shown, that an optimal monotonicity function that analyzes a combination of input values should have three to five input values.

Another criteria for a monotonicity function or its implementation as a monotonicity instruction of a processor's ALU is its tolerance. In signal processing, two values which are close and vary slightly are termed “equal.” Mathematics of such values, however, vary within a certain tolerance. For example, the values a and b are termed “equal,” if abs (a−b)<ref, where “abs (a−b)” denotes the absolute value of the difference. The value ref denotes a certain threshold. It is, therefore, necessary for digital signal processing to consider a certain uncertainty of values when evaluating the monotonicity of values.

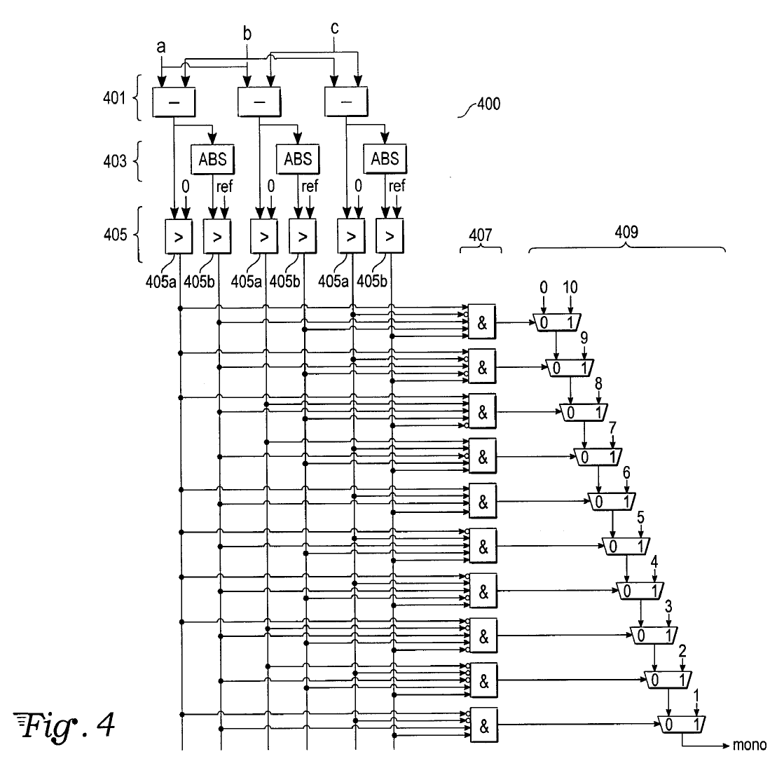

FIG. 4 shows an exemplary embodiment of a circuit 400 of the present invention that can be used for the execution of an instruction in the ALU of a processor (for example, in the processor of FIG. 3) to calculate a monotonicity value (mono value) out of three input values a, b, and c. However, the disclosure is not limited to three input values. Other embodiments of the disclosure can have a higher number of input values, e.g., four, five, or more.

Modules in FIG. 4 are used to compare all input values a, b, and c and to determine which of the absolute differences of all input values a, b, and c are higher than a certain threshold value (reference value ref). This threshold value ref can have any value.

In FIG. 4 in a first step, the difference (a signed value) of all input values a, b, and c is calculated by a plurality of subtractors 401. For each of the so-calculated differences the absolute value is determined by a plurality of of absolute value modules 403. The so calculated differences (signed and absolute) are passed to a plurality of comparators 405. The signed differences calculated by the plurality of subtractors 401 are compared with zero by a first plurality of comparators 405a. Hence each of the first plurality of of comparators 405a signals which of the inputs of the corresponding plurality of subtractors 401 is greater. A second plurality of comparators 405b are used to determine which of the absolute differences (computed by the plurality of absolute difference modules 403) are greater than a given threshold ref.

The second plurality of comparators 405b use the absolute differences to determine if two input values are within a certain tolerance ref, i.e., to determine the equality of two input values. If, for example, the input values a and b are so close that their difference abs (a−b) is “greater than” (or “less than” in other embodiments) a given threshold value ref, the corresponding one of the second plurality of comparators 405b will signal true.

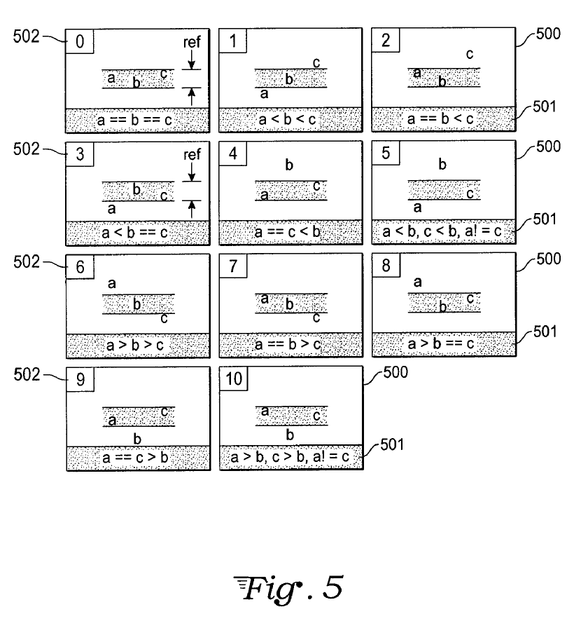

A plurality of combinatorial logic blocks 407 uses the output signals of the plurality of comparators 405 to determine the monotonicity of the input signals a, b, and c according to a case diagram shown in FIG. 5. The resulting signals of the plurality of combinatorial logic blocks 407 are used to control a plurality of multiplexing units 409. In the embodiment of the disclosure shown in FIG. 5, the control signals of the plurality of combinatorial logic blocks 407 are mutually exclusive and select an output value (mono value) using the plurality of multiplexing units 409.

Hence, the embodiment shown in FIG. 4 considers a certain tolerance (threshold value ref) to evaluate the correlation of input values described below with reference to FIG. 5. It is noted that the threshold value ref can be varied during runtime which, therefore, allows flexible adjustment of the tolerance depending on the input signals or the algorithms used.

With reference to FIG. 5, an overview of a set of combinations of three input values a, b, and c describes various monotonicity cases. Each of the boxes 500 illustrates a monotonicity case for these values and contains a graphical illustration of three values a, b, and c. Each of the boxes 500 further contain the condition 501 that describes the monotonicity which is shown at the bottom and a mono value (see FIG. 4) shown in the upper left corner 502 which represents the monotonicity case. For example, the first condition (a==b==c) means a is equal to b and b is equal to c; the third condition (a==b<c) means a is equal to b and both a and b are lower than c; and, e.g., a!=c means a is not equal to c.

Each of the boxes 500 graphically shows the values a, b, and c. A stripe in the middle denotes a tolerance defined by a threshold value ref. For instance, the first box 500 with the mono value 0 has the monotonicity condition a==b==c whereas all three values a, b, and c are within a certain tolerance ref and, hence, are treated as equal.

The box 500 with the mono value 1 shows strong monotonically increasing values, the box 500 with the mono value 6 shows strong monotonically decreasing values. The boxes 500 with the mono value 2 and 7 show monotonicity cases where a and b are within a certain tolerance and c is higher or lower respectively. The boxes 500 with the mono value 3 and 8 show monotonicity cases where b and c are within a certain tolerance and a is lower or higher respectively. The boxes 500 with the mono value 4 and 9 show monotonicity cases where a and c are within a certain tolerance and b is higher or lower respectively. The boxes 500 with the mono value 5 and 10 show the remaining monotonicity cases where a and c are not within a certain tolerance and b is higher or lower respectively.

The mono values provided in the upper left corner 502 of the boxes 500 in FIG. 5 are identical to the mono values selected by the multiplexing unit 409 in FIG. 4. However, it is to be noted, that for the monotonicity cases represented by the boxes 500 in FIG. 5, any other mono values can be chosen in other embodiments of the disclosure in order to allow a better implementation of algorithms that use the mono values.

Using the ALU factory 300 shown in FIG. 3, the monotonicity instruction of the embodiment shown in FIG. 4 which uses only three input values can easily be used to determine the monotonicity of three input values, e.g., three values stored in the ALU-A registers 307, if the ALUs 315 of type ALU-B provide the monotonicity instruction for only three input values according to FIG. 4. If ARUx denotes the ALU-A registers 307 (x can be a number from 0 to 3) and ACCUy denotes the ALU-B registers 317 (y can be a number from 0 to 3) an example of monotonicity instructions in the ALUs of type ALU-B 315 could be:

| | |
|---|---|
| { | |
| | MONO.FORMAT (7); |
| } | |
| { | |
| | ACCU0=MONO(ARU0, ARU1, ARU2); |
| | ACCU1=MONO(ARU0, 20, ARU1); |
| | ACCU2=MONO(ARU1, 20, ARU2); |
| | ACCU3=MONO(ARU2, 20, ARU3); |
| } | |

In this example, a cycle is represented by a pair of braces. In a first cycle, the threshold value ref is set to 7 using a special instruction MONO.FORMAT. The instruction MONO.FORMAT configures the behaviour of all subsequent calls to the MONO instruction. The instruction MONO is a monotonicity instruction. In this example, three values of the ARU-A registers 307 are analyzed, whereas in the second to fourth call to MONO two of them are always compared to a constant value 20. The subsequent handling of the results of the monotonicity instruction in algorithms is not demonstrated in the example above as they are not of relevance.

The above examples performs four checks for monotonicity and subsequent stages of the ALU factory can, for example, use the results of the monotonicity function to check whether the provided input values match the defined quality criteria given by a mono value and defined by a threshold ref.

By assigning different values 502 to the monotonicity cases which are illustrated by the boxes 500 in FIG. 5 and, hence, assigning new values in the plurality of multiplexing units 409 (FIG. 4) to multiplexers for the cases the return values of the monotonicity instruction can be tailor made to better suit processing in algorithms.

An exemplary embodiment for a call of a monotonicity processor instruction is:

ACCUy=(operand1, operand2, operand3)

An exemplary embodiment for a call of a processor instruction to configure the threshold value is:

MONO.FORMAT (threshold)

Another embodiment for a call of a monotonicity processor instruction with an immediate threshold value can be:

ACCUy=(threshold, operand1, operand2, operand3)

An exemplary embodiment for a processor instruction that allows configuration of the monotonicity return values (values 502 in the table shown in FIG. 5) is the following instruction, wherein the instruction is called once for each case.

MONO.TABLE=(CaseIndex,ReturnValue)

One advantage of the present method and apparatus is that the monotonicity of a series of values can be evaluated in a single clock cycle. Moreover, the method and apparatus according to the description given herein enables one to set and even to adjust a tolerance value ref which allows an uncertainty in the monotonicity equations. Configurable monotonicity case tables (see FIG. 5) allow customization of the return values for efficiently handling of the return values in the used algorithms.

In the foregoing specification, the present invention has been described with reference to specific embodiments thereof. It will, however, be evident to a skilled artisan that various modifications and changes can be made thereto without departing from the broader spirit and scope of the present invention as set forth in the appended claims. For example, particular embodiments describe a number of registers, ALUs, and multiplexers per stage. A skilled artisan will recognize that these numbers are flexible and the quantities shown herein are for exemplary purposes only. Additionally, a skilled artisan will recognize that various numbers of stages may be employed for various array sizes and applications. These and various other embodiments are all within a scope of the present invention. The specification and drawings are, accordingly, to be regarded in an illustrative rather than a restrictive sense.

What is claimed is:

1. A processor architecture used in digital signal processing to efficiently analyze monotonicity of a set of N input values, the processor architecture comprising:
means for comparing the set of N input values and generating N comparison signals, each of the N comparison signals indicating a higher value of two different input values from the set of N input values;
means for calculating N absolute differences of the two different input values;
a set of N comparators coupled to the means for calculating N absolute differences and configured to determine which of the N absolute differences are greater than a reference value, each of the set of N comparators further configured to generate a second comparison signal indicating whether a absolute difference is greater than the reference value;
a plurality of logic elements coupled to the set of N comparators and configured to check a plurality of cases of monotonicity, each logic element of the plurality of logic elements configured to determine a unique case of monotonicity using one of the N comparison signals and the second comparison signal and generating a control signal, the control signal indicating whether the unique case of monotonicity of the plurality of cases of monotonicity is valid; and
a selection unit coupled to the plurality of logic elements and configured to select a monotonicity output value.

2. The processor architecture of claim 1 wherein the selection unit is configured to use the control signals generated by the plurality of logic elements to select the monotonicity output value from a set of output values, the monotonicity output value being a result of a monotonicity instruction.

3. The processor architecture of claim 1 wherein the number N of input values is at least 3.

4. The processor architecture of claim 1 further comprising:
a main control unit;
a global address generation unit configured to be responsive to the main control;
an interface to a memory and coupled to the global address generation unit; and
at least two slices, each of the at least two slices configured to operate on a unique data set, the at least two slices coupled to the main control unit and the interface to a memory and including at least one ALU-factory, the ALU-factory having:
at least two input registers;
at least two ALU-A output registers;
at least two ALU-B output registers;
a first plurality of ALUs coupled to the at least two ALU-A output registers, each of the first plurality of ALUs is configured to send a computational result to the ALU-A output registers; and
a second plurality of ALUs coupled to the at least two ALU-B output registers, each of the second plurality of ALUs is configured to send a computational result to the ALU-B output registers.

5. The processor architecture of claim 4 wherein each of a plurality of instructions provided by each of the first plurality and the second plurality of ALUs within the ALU-factory is configured to be executed within a single clock cycle.

6. The processor architecture of claim 1 further comprising:
at least two ALU-C output registers; and
an ALU coupled to each of the at least two ALU-C registers and configured to send a computational result to a corresponding one of the at least two ALU-C output.

7. The processor architecture of claim 6 wherein each of a plurality of instructions provided by each ALU coupled to the at least two ALU-C output registers is configured to be executed within a single clock cycle.

8. A processor architecture used in digital signal processing to efficiently analyze monotonicity of a set of N input values, the processor architecture comprising:
a comparison logic circuit configured to compare the set of N input values and generate N comparison signals, each of the N comparison signals indicating a higher value of two different input values from the set of N input values;
a calculation circuit coupled to the comparison logic circuit and configured to calculate N absolute differences of the two different input values;
a set of N comparators coupled to the calculation circuit configured to determine which of the N absolute differences are greater than a reference value, each of the set of N comparators further configured to generate a second comparison signal indicating whether a absolute difference is greater than the reference value;
a plurality of logic elements coupled to the set of N comparators and configured to check a plurality of cases of monotonicity, each logic element of the plurality of logic elements configured to determine a unique case of monotonicity using one of the N comparison signals and the second comparison signal and generating a control signal, the control signal indicating whether the unique case of monotonicity of the plurality of cases of monotonicity is valid; and
a selection unit coupled to the plurality of logic elements and configured to select a monotonicity output value.

9. The processor architecture of claim 8 wherein the selection unit is configured to use the control signals generated by the plurality of logic elements to select the monotonicity output value from a set of output values, the monotonicity output value being a result of a monotonicity instruction.

10. The processor architecture of claim 8 wherein the number N of input values is at least 3.

11. The processor architecture of claim 8 further comprising:
a main control unit;
a global address generation unit configured to be responsive to the main control;
an interface to a memory and coupled to the global address generation unit; and
at least two slices, each of the at least two slices configured to operate on a unique data set, the at least two slices coupled to the main control unit and the interface to a memory and including at least one ALU-factory, the ALU-factory having:
at least two input registers;
at least two ALU-A output registers;
at least two ALU-B output registers;
a first plurality of ALUs coupled to the at least two ALU-A output registers, each of the first plurality of ALUs is configured to send a computational result to the ALU-A output registers; and
a second plurality of ALUs coupled to the at least two ALU-B output registers, each of the second plurality of ALUs is configured to send a computational result to the ALU-B output registers.

12. The processor architecture of claim 11 wherein each of a plurality of instructions provided by each of the first plurality and the second plurality of ALUs within the ALU-factory is configured to be executed within a single clock cycle.

13. The processor architecture of claim 8 further comprising:
at least two ALU-C output registers; and
an ALU coupled to each of the at least two ALU-C registers and configured to send a computational result to a corresponding one of the at least two ALU-C output.

14. The processor architecture of claim 13 wherein each of a plurality of instructions provided by each ALU coupled to the at least two ALU-C output registers is configured to be executed within a single clock cycle.

15. A method of determining monotonicity of a set of N input values, the method comprising:
pairwise comparing the set of N input values to determine a higher value of two different input values from the set of N input values;
calculating N absolute differences of the two different input values;
determining which of the N absolute differences are greater than a given reference value;
checking a plurality of cases of monotonicity, the checking performed using a set of monotonicity conditions evaluated with a result of the step of pairwise comparing and the step of determining which of the N absolute differences are greater, the checking generating control signals indicating which case of monotonicity of the plurality of cases of monotonicity is valid; and
using the generated control signals to select a monotonicity output value from a set of output values, the monotonicity output value being a result of a monotonicity instruction.

16. The method of claim 15 further comprising selecting a number N of the set of N input values to be at least 3.

17. The method of claim 15 further comprising selecting a threshold value reference to be used in checking the plurality of cases of monotonicity to allow a degree of uncertainty, the degree of uncertainty being a tolerance defined by the threshold value reference, the tolerance defining an upper bound of the absolute value of the difference of a fist input value and a second input value.

18. A method of claim 17 wherein the threshold value reference is configurable via an instruction.

19. A method of claim 15 wherein the step of checking a plurality of cases of monotonicity is executed within a single clock cycle.

20. A method of claim 15 wherein the set of output values is configurable via an instruction.
